(19) United States
(12) Patent Application Publication
(10) Pub. No.: US 2011/0172851 A1
(43) Pub. Date: Jul. 14, 2011

(54) System incorporating software program and/or hardware circuitry for intercepting and interpreting or altering commands for generating I/O activity for enabling real-time external or user interface by sending substitute data or signals to automotive vehicle's electrical or electronic systems

(76) Inventor: Khaliqur Rahman, Torrance, CA (US)

(21) Appl. No.: 12/930,231

(22) Filed: Dec. 31, 2010

Related U.S. Application Data
(60) Provisional application No. 61/291,809, filed on Dec. 31, 2009.

(51) Int. Cl. G06F 17/00

(52) U.S. Cl. 701/2

(57) ABSTRACT

A system is described to provide access to an automotive vehicle's input and output devices and making those available for an external system or device, while preserving original functionality of the input and output devices in the vehicle. The system includes a set of circuits coupled to the vehicle's input and output devices and a controller subsystem coupled to the these set of circuits. The system also includes an interface circuit coupled to the controller subsystem as well as to the external system or device being added by the user.

### CROSS-REFERENCE TO RELATED APPLICATIONS

Provisional application No. 61/291,809, filed on Dec. 31, 2009.

### BACKGROUND OF THE INVENTION

1. Field of the Invention

This invention generally relates to automotive electrical and electronic systems and in particular to interfacing after market systems, applications or devices to in-vehicle input and output devices.

2. Description of the Related Art

With the explosive growth of electronic technologies, automotive industry has gone through a revolution where these new electronics based technologies have taken over almost every aspect of in-vehicle systems. Modern age automotive vehicles have many controls and information displays available to the user which provide an unprecedented degree of comfort, control, awareness and safety to the driver as well as passengers in the vehicle. Few examples of these systems are in-vehicle entertainment, climate control, vehicle engine and other systems' status, navigation units, telecommunication facilities etc. Many more are constantly being added as electronic technology continues making inroads into every aspect of automotive industry. All these features which come as part of the vehicle from the manufacturer are generally called OE features. Because of these features, there are plenty of input and output devices available to the driver and passengers.

On the other hand, there is an ever increasing need of adding a range of third party after market devices and features to automotive vehicles to enhance the utility and/or enjoyment of an automotive vehicle. Apart from personal or family uses, there is a broad range of industrial and commercial applications where there is a need to supplement a vehicle with consumer specific devices or equipment which are readily available and provide extra features needed by a wide range of customers. Examples of such systems are Hands-free phones, Auxiliary power systems, security apparatus, personalized entertainment gadgets etc.

In such a scenario, a basic need arises to provide the intended user with means to easily interact with the new device or feature being added to the vehicle. With the prior art, most common form of these interfaces consist of mechanically mounted switches, displays, speakers, indicators or any other type of input/output devices to the dashboard, rear view mirror, glove boxes, cigarette lighter or any other places where these input or output devices can be made accessible to the user. In addition to that, with the prior art, new wiring may have to be added to connect these inputs or outputs to the new after-market device being installed. Any of these methods to install extra input and/or output devices not only degrades aesthetics of vehicle interiors but may also cause to compromise mechanical integrity and longevity of dash board or firewalls so precisely manufactured into modern vehicles. It may also expose some chemicals which have been properly sealed or coated during the manufacturing process.

### BRIEF SUMMARY OF THE INVENTION

This invention provides an elegant solution by allowing the required application to directly access inputs and outputs already available in an automotive vehicle, without disturbing or removing any of the existing systems or devices in the said vehicle, thereby eliminating a need to add and mount expensive and difficult to install switches, control panels, displays or other types of input and output devices.

According to one aspect of the invention, a system is provided to gain access to an automotive vehicle's input and output devices and making those available for an external system or device, while preserving original functionality of the input and output devices in the vehicle. The system includes a set of circuits coupled to the vehicle's input and output devices and a controller subsystem coupled to the said set of circuits. The system also includes an interface circuit coupled to the controller subsystem as well as to the external system or device being added by the user.

In one embodiment of the invention, the controller decodes user action on an input device available in the vehicle by interpreting analog signal coming out of the vehicle's steering wheel controls and selectively forwards that information to either the external system or user device or forwards it to the vehicles subsystem that was the original recipient of that action. The said controller makes available unique user actions on the said input device that allow user to easily direct commands to external system or user device or towards original recipient of the said user action.

In another embodiment of the current invention, the controller interprets user actions on the vehicle Radio buttons, knobs or other user inputs and selectively forwards that action to either external system or user device or forwards it to the vehicle subsystem that was the original recipient of that action. The said controller adds extra action modes on Radio controls to allow user to selectively direct his or her actions to either external system or user device or perform normal Radio operation.

In one aspect of one embodiment of the invention, the controller monitors the status of the external system or user device and determines occurrence of active mode or state of the external system or user device and upon said occurrence, directs a set of user inputs available in the vehicle towards external system or user device for the entire duration or part thereof of such active mode or state.

In another aspect of one embodiment of the invention, the controller monitors the status of the external system or user device and determines occurrence of a particular active mode or state of the external system or user device and upon said occurrence, directs an adjustable type of user inputs available in the vehicle towards external system or user device for the entire duration or part thereof of such active mode or state, to adjust a set of internal parameters of external system or user device in a smoothly variable fashion.

In yet another aspect of one embodiment of the current invention, the controller monitors the status of the external system or user device and determines occurrence of active mode or state of the external system or user device and upon said occurrence, directs a set of user output devices available in the vehicle towards external system or user device for the entire duration or part thereof of such active mode or state.

### BRIEF DESCRIPTION OF THE DRAWINGS

The accompanying drawings which are incorporated in and constitute a part of this specification, explain the object, advantages and principles of the invention. These drawing are merely few examples of many applications possible under this invention and in no way restrict application of this invention to many other scenarios.

FIG. 1 is a block diagram of a vehicle's steering wheel controls usage application according to one embodiment of the invention.

FIG. 2 is a block diagram of a vehicle's Radio controls and display usage application according to another embodiment of the invention.

### DETAILED DESCRIPTION

In the following description, specific details are set forth in order to provide a thorough understanding of the present invention. However, it will be apparent to one skilled in the art that the present invention may be practiced without these specific details. In other instances, well known circuits, structures and techniques have not been shown in detail in order to avoid obscuring the present invention.

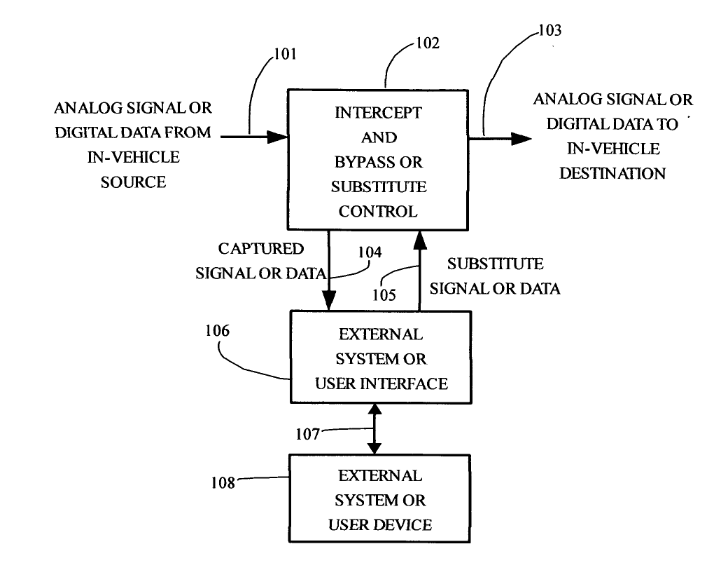

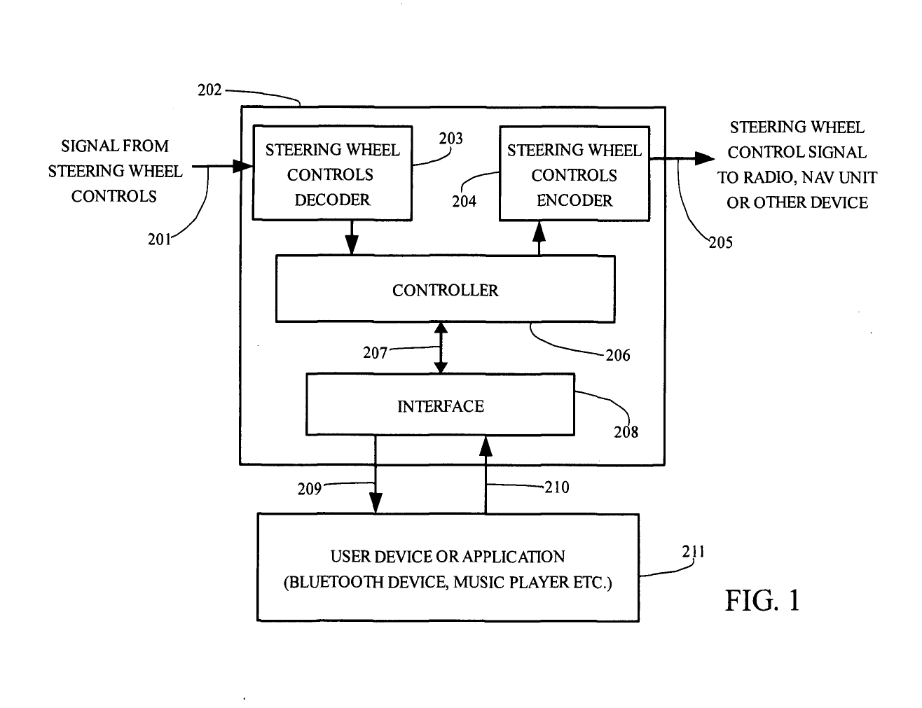

FIG. 1 depicts a steering wheel controls application according to one embodiment of the present invention. In this embodiment, main block 202 consists of various distinct blocks interconnected as shown. SIGNAL FROM STEERING WHEEL CONTROLS 201 is received by STEERING WHEEL CONTROLS DECODER 203 which converts the user action applied to the steering wheel control, into a voltage value. In this embodiment, each user action is originally defined as a specific value of resistance value across steering wheel control terminals. Once this resistance value is decoded into a voltage value, it is converted to a digital value by an Analog to Digital Converter which is an integral part of the block identified as CONTROLLER 206. In one aspect of one embodiment of the current invention, this digital value is processed in conjunction with time duration of the input action on the steering wheel control to lookup into a decoder map inside the CONTROLLER 206 to determine subsequent destination and value of the resulting action. If the destination is USER DEVICE OR APPLICATION 211 then the said action is transferred to INTERFACE 208 via 207. INTERFACE 208 converts the said action into a signal appropriate for the USER DEVICE OR APPLICATION and drives that signal out via 209. Else if the destination is STEERING WHEEL CONTROL SIGNAL TO RADIO, NAV UNIT OR OTHER DEVICE 205 then the said action is transferred to STEERING WHEEL CONTROLS ENCODER 204 so that it is converted back into a specific resistance value with appropriate time duration and driven onto the desired destination via 205.

Another aspect of this embodiment is inclusion of status signal 210 coming from USER DEVICE OR APPLICATION 211 and properly decoded by the INTERFACE 208 and sent via 207 to the CONTROLLER 206. This input is continuously monitored by the CONTROLLER 206 to determine if USER DEVICE OR APPLICATION 211 has entered an active mode where user actively needs to interact with it to perform the desired functions associated with the USER DEVICE OR APPLICATION 211. Under this condition, CONTROLLER 206 automatically directs a set of steering wheel input actions for the whole duration of its active mode or part thereof to USER DEVICE OR APPLICATION 211. In another aspect of this embodiment, specific action(s) are also generated and sent to STEERING WHEEL CONTROL SIGNAL TO RADIO, NAV UNIT OR OTHER DEVICE 205 to show user device status and further facilitate proper operation of the USER DEVICE OR APPLICATION 211, as may be required.

Overall result of this embodiment is a seamless integration of USER DEVICE OR APPLICATION 211 into automotive vehicle from user perspective and a very close fit into vehicle's electrical and aesthetic environment.

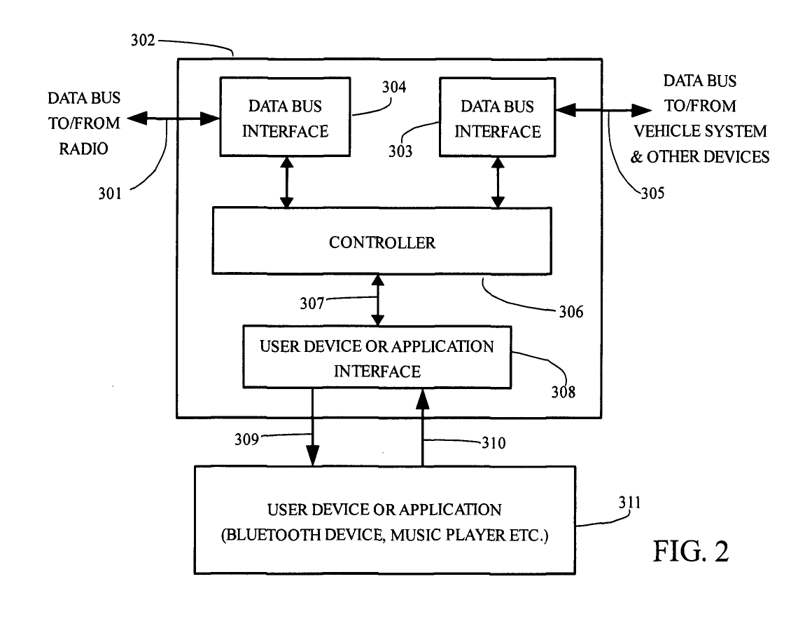

FIG. 2 shows another embodiment of the invention where a USER. DEVICE OR APPLICATION 311 is provided access to vehicle input and outputs including usage of Radio buttons, knobs, display etc. Additionally this embodiment also allows access to vehicle input and output resources other than Radio, such as Ignition Key and many other status values plus a possible access to on-dash status display of Radio related information, which can blend information about USER DEVICE OR APPLICATION 311 by virtue of this embodiment.

In this embodiment, shown in FIG. 2, DATA BUS TO/FROM RADIO enters main block 302 as a signal 301 and connects to DATA BUS INTERFACE 304. DATA BUS INTERFACE 304 properly encodes and decodes digital data exchange with the Radio and extracts and generates these data frames and passes them across to CONTROLLER 306 for further processing in each direction. The composition of DATA BUS INTERFACES 304 as well as 303 are specific to the vehicle's data bus specifications and ensures reliable communication according to those specifications. DATA BUS INTERFACE 303 provides proper data exchange with DATA BUS TO/FROM VEHICLE SYSTEM & OTHER DEVICES via bus signal 305 and establishes a data link between CONTROLLER 306 and vehicle's bus. In this embodiment, CONTROLLER 306 is also coupled to the USER DEVICE OR APPLICATION 311 through USER OR APPLICATION INTERFACE 308 and via output signals 309 and input signals 310. In one aspect of this embodiment, CONTROLLER 306 maintains a transparent data connection between Radio and Vehicle System & Other Devices, during idle or inactive state of USER DEVICE OR APPLICATION 311. This transparent connection ensures proper operation of Radio and it associated functions. In one aspect of this embodiment, during this state, CONTROLLER 306 is monitoring all user actions on the Radio controls and applies these actions in conjunction with the timing of those actions, into a lookup map to determine if user has entered a USER DEVICE OR APPLICATION 311 related command. When such a command is determined to have been entered by the user, CONTROLLER 306 sends that command to the USER DEVICE OR APPLICATION 311 via interface 308 and generates proper signal on output 309. If required, that command is also blocked from being sent to vehicle system.

Another aspect of this embodiment is inclusion of status signal 310 coming from USER DEVICE OR APPLICATION 311 and properly decoded by the INTERFACE 308 and sent via 307 to the CONTROLLER 306. This input is continuously monitored by the CONTROLLER 306 to determine if USER DEVICE OR APPLICATION 311 has entered an active mode where user actively needs to interact with it to perform the desired functions associated with the USER. DEVICE OR APPLICATION 311. Under this condition, CONTROLLER 306 automatically directs a set of user input actions on the Radio controls for the whole duration of its active mode or part thereof to USER DEVICE OR APPLICATION 311. In another aspect of this embodiment, specific data frames are also generated and sent to VEHICLE SYSTEM & OTHER DEVICES 305 to show user device status and further facilitate proper operation of the USER DEVICE OR APPLICATION 311, as may be required.

Overall result of this embodiment also is a seamless integration of USER DEVICE OR. APPLICATION 311 into automotive vehicle from user perspective and a very close fit into vehicle's electrical and aesthetic environment.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A system comprising:
An intercept circuit which is coupled to analog signal and/or digital data from in-vehicle source; and a circuit coupled to analog signal and/or digital data to in-vehicle destination with an ability to bypass or substitute analog signal and/or digital data received from the said in-vehicle source; and a controller subsystem capable of interpreting and reproducing said analog signal or digital data; and an interface circuit coupled to the controller subsystem capable of receiving commands and status signals in analog or digital form from external system or user device and also capable of generating signals in analog or digital form for proper connection to the said external system or user device, and said controller's ability to interpret and process said commands from the said external system or user device and translating those commands into proper format for subsequent transmission to in-vehicle destination in an appropriate format.

2. The system of claim 1, wherein a determination is made to selectively forward a user action on the vehicle input device to either in-vehicle destination or towards external system or user device.

3. The system of claim 1, wherein a determination is made on a continuous basis about the current state of external system or user device as to whether it is idle, active or another state as may be applicable to said external system or user device.

4. The system of claim 1, wherein said controller is capable of generating commands to produce analog signals or digital data signals towards in-vehicle destinations, to effect desired responses or indications in audible, visual or other forms onto the output devices available in the vehicle.

5. The system of claim 1, wherein a determination is made to selectively forward an entire subset of commands from the said in-vehicle source to the external system or user device for as long as a predetermined set of conditions exist with reference to in-vehicle source, in-vehicle destination and external system or user device.
